(19) United States
(12) Patent Application Publication
(10) Pub. No.: US 2006/0288008 A1
(43) Pub. Date: Dec. 21, 2006

(54) Append/read lock compatibility in a distributed file system

(76) Inventors: Sukadev Bhattiprolu, Beaverton, OR (US); Craig F. Everhart, Chapel Hill, NC (US); Venkateswarara Jujjuri, Beaverton, OR (US); Soumitra Sarkar, Cary, NC (US)

Correspondence Address: LIEBERMAN & BRANDSDORFER, LLC, 802 STILL CREEK LANE, GAITHERSBURG, MD, 20878, US

(21) Appl. No.: 11/158,225

(22) Filed: Jun. 21, 2005

(51) Int. Cl. G06F 17/30

(52) U.S. Cl. 707/9

(57) ABSTRACT

Extensions are provided to a lock for supporting concurrency of read and write operations of a shared resource in a computer system. Both reader and writer modes are maintained. In addition, an append mode and a prefix mode are provided. The append mode supports non-exclusive access to the shared resource while enabling modification of the shared resource after a marker. The prefix mode supports non-exclusive access to read the shared resource prior to the marker. Lock mode requests to the shared resources are mediated to ensure compatibility of granted lock modes with lock mode requests.

### BACKGROUND OF THE INVENTION

1. Technical Field

This invention relates to management of a shared object in a distributed file system. More specifically, a lock is provided to support concurrent read and write operations so that a strong consistency model may be maintained in the system.

2. Description Of The Prior Art

FIG. 1 is a prior art block diagram (10) of a distributed file system including a server cluster (20), a plurality of client machines (12), (14), and (16), and a storage area network (SAN) (30). Each of the client machines communicate with one or more server machines (22), (24), and (26) over a data network (40). Similarly, each of the client machines (12), (14), and (16) and each of the server machines in the server cluster (20) are in communication with the storage area network (30). The storage area network (30) includes a plurality of shared disks (32) and (34) that contain only blocks of data for associated files. Similarly, the server machines (22), (24), and (26) contain only metadata pertaining to location and attributes of the associated files. Each of the client machines may access an object or multiple objects stored on the file data space of the SAN (30), but may not access the metadata space. In opening the contents of an existing file object on the storage media in the SAN (30), a client machine contacts one of the server machines to obtain metadata and locks. Metadata supplies the client with information about a file, such as its attributes and location on storage devices. Locks supply the client with privileges it needs to open a file and read or write data. The server machine performs a look-up of metadata information for the requested file within metadata space of the SAN (30). The server machine communicates granted lock information and file metadata to the requesting client machine, including the location of all data blocks making up the file. Once the client machine holds a lock and knows the data block location(s), the client machine can access the data for the file directly from a shared storage device attached to the SAN (30).

As shown in FIG. 1, the illustrated distributed file system separately stores metadata and data. Metadata, including the location of blocks of each file on shared storage, are maintained on high performance storage at the server machines (22), (24), and (26). The shared disks (32) and (34) contain only blocks of data for the files. This distribution of metadata and data enables optimization of data traffic on the shared disks (32) and (34) of the SAN (30), and optimization of the metadata workload. The SAN environment offloads the distributed file system servers by removing their data tasks. Without data to read and write, the file server is available to perform more transactions than in the prior art which requires the file server to perform data read and write transactions.

Each file in the SAN (30) is divided into a plurality of segments. Reader-writer locks are supported in the file system shown in FIG. 1 to manage the shared objects therein. The basic mechanics and structure of reader-writer locks are well known. A reader-writer lock allows multiple reading processes (“readers”) to simultaneously access a shared object, while a writing process (“writer”) must have exclusive access to the shared object before performing any updates for consistency. Although reader-writer locks are known in the art for management of shared resources, performance is a limitation that is significantly affected in a shared object file system. FIG. 2 is a matrix (80) demonstrating compatibility of a reader lock and a writer lock to describe which locks can be held concurrently by different lock holders. The horizontal projection indicates the granted lock mode (82), and the vertical projection indicates the requested lock mode (84). The +'s indicate that the requested lock can be granted in conjunction with the currently held lock, and the −'s indicate that the request is in conflict with the current lock state. As shown, multiple readers may be granted for a shared resource, but neither a reader and writer nor multiple writer locks may be granted concurrently.

FIG. 3 is a flow chart (100) illustrating a prior art method of a server managing a shared object in a distributed file system with a conventional reader-writer lock. In the method illustrated herein, the system includes two client machines, client₁ and client₂, a server, and SAN having shared resources that supports reading and writing of data. At some point in time, client₁ determines a need to obtain a lock for the shared object. The server receives a lock request from client₁ (102). In response to the lock request, the server conducts an internal test to determine if the requested lock could be held by client, concurrently with all or any locks currently held by the client₂ machine (104). If the response to the test at step (104) is negative, the server sends a lock downgrade request to client₂ in the form of a message requesting release of the incompatible lock (106) and then waits to receive a reply from client₂ (108). Following step (108) or a positive response to the test at step (104), the server returns the requested lock to client, (110). In one embodiment, the server may then increase the requested lock strength to the maximum value compatible with all granted locks. Accordingly, as shown herein a server monitors lock requests received from a client to ensure compatibility with all current locks.

FIG. 4 is a flow chart (150) illustrating a prior art method of a client requesting a lock for a shared object in a distributed file system with a conventional reader-writer lock.

In the method illustrated herein, the system includes two client machines, client₁ and client₂, a server, and SAN having shared resources that supports reading and writing of data. At some point in time, client₁ determines it has a need for a level x lock or stronger (152). Client₁ conducts a test to determine if it has a level x lock or stronger (154). If the response to the test at step (154) is positive, client₁ may proceed with access to the shared object (160). However, if the response to the test at step (154) is negative, client₁ requests a level x lock from the server (156). Following receipt of a reply from the server (158), client, proceeds with access to the shared object (160). Accordingly, as shown herein a client sends lock requests to a server to ensure the ability to access a shared resource.

Generally, file systems implement data locks that provide strong consistency between readers and writers. When a client wants to read a shared object, the client must obtain a reader lock to proceed with the action. Similarly, if a client wants to write to a shared object, the client must obtain a write lock prior to proceeding with the action.

Lock contention is a byproduct when data is shared among one writer and multiple readers in a strong consistency model. Contention loads the network and results in slow application progress. Accordingly, there is a desire to provide a lock for a shared object that supports the basic characteristics of a conventional reader-write lock with reduced lock contention.

### SUMMARY OF THE INVENTION

This invention comprises a modified reader-writer lock to enhance management of a shared object.

In one aspect of the invention, a lock is provided with a reader mode, a writer mode, an append mode, and a prefix mode. The reader mode supports non-exclusive access to read a shared object. The writer mode supports exclusive access to modify a shared object. The append mode supports non-exclusive access to a shared object and supports a modification to the object after a marker. The prefix mode supports non-exclusive access to read the object earlier than the marker. In addition, a manager is provided to mediate a lock request response to the lock modes.

In another aspect of the invention, a method is provided for managing a shared object in a computer system. A reader-writer lock is provided to support additional modes of operation. The modes include a reader mode, a writer mode, an append mode, and a prefix mode. The reader mode supports non-exclusive access to read a shared object. The writer mode supports exclusive access to modify a shared object. The append mode supports non-exclusive access to a shared object and supports a modification to the object after a marker. The prefix mode supports non-exclusive access to read the shared object earlier than the marker. Mode requests are mediated within the lock in response to the additional lock modes.

In yet another aspect of the invention, an article is provided with a computer-readable signal bearing medium. Means in the medium are provided to support management of a shared object, with the means including instructions to support concurrency of lock modes. The instructions support a reader mode, a writer mode, an append mode, and a prefix mode. The reader mode supports non-exclusive access to read a shared object. The writer mode supports exclusive access to modify a shared object. The append mode supports non-exclusive access to a shared object and supports a modification to the object after a marker. The prefix mode supports non-exclusive access to read the object earlier than the marker. In addition, means in the medium are provided for mediating a lock request responsive to the modes.

Other features and advantages of this invention will become apparent from the following detailed description of the presently preferred embodiment of the invention, taken in conjunction with the accompanying drawings.

### BRIEF DESCRIPTION OF THE DRAWINGS

FIG. 1 is a block diagram of a prior art distributed file system.

FIG. 2 is a compatibility matrix of a prior art reader-writer lock.

FIG. 3 is a flow chart of a prior art method for managing a shared object in a distributed file system from the perspective of a server.

FIG. 4 is a flow chart of a prior art method for managing a shared object in a distributed file system from the perspective of a client.

FIG. 5 is a compatibility matrix of a lock according to the preferred embodiment of this invention.

FIG. 6 is a flow chart illustrating a method for a server to grant a lock to a client.

FIG. 7 is a flow chart illustrating a method for a client to request a reader lock from the server.

FIG. 8 is a flow chart illustrating a method for managing a lock downgrade communication of the lock received by the client from the server.

FIG. 9 is a block diagram illustrating communication between a server and multiple clients within the parameters of the lock, and is suggested for printing on the first page of the issued patent.

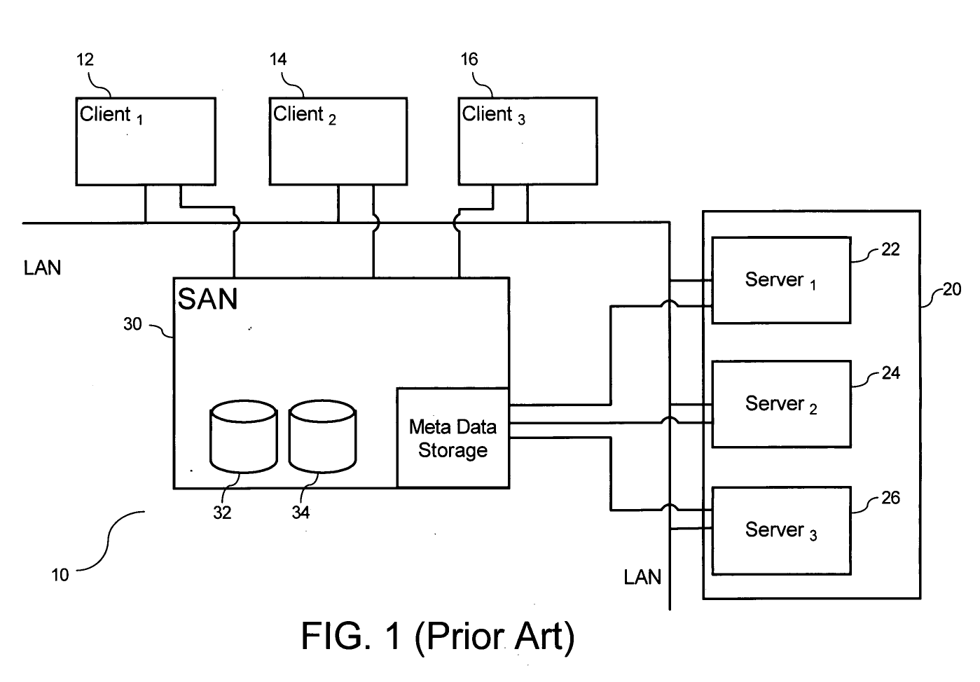

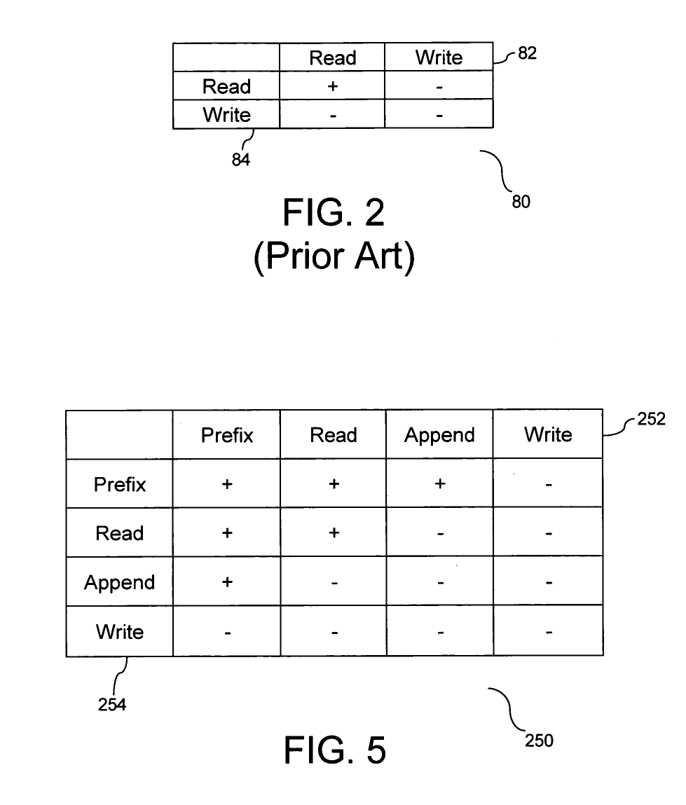

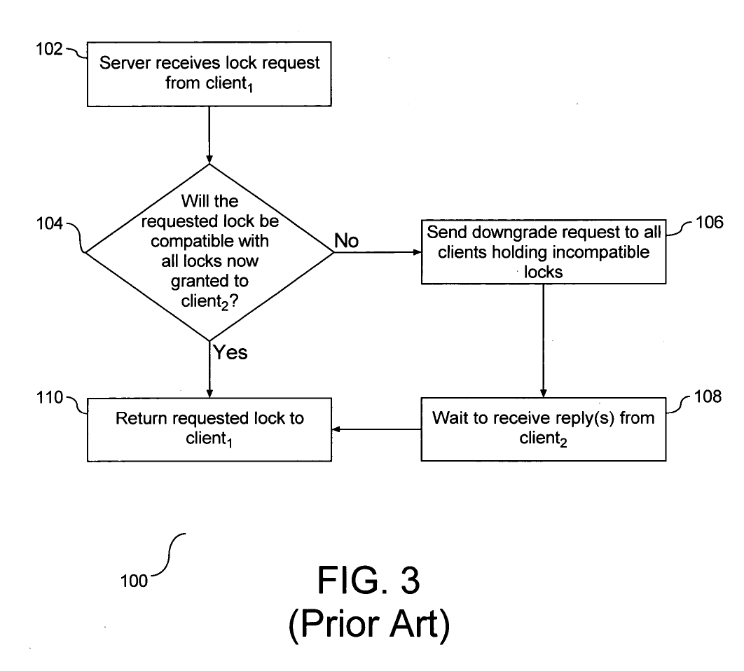

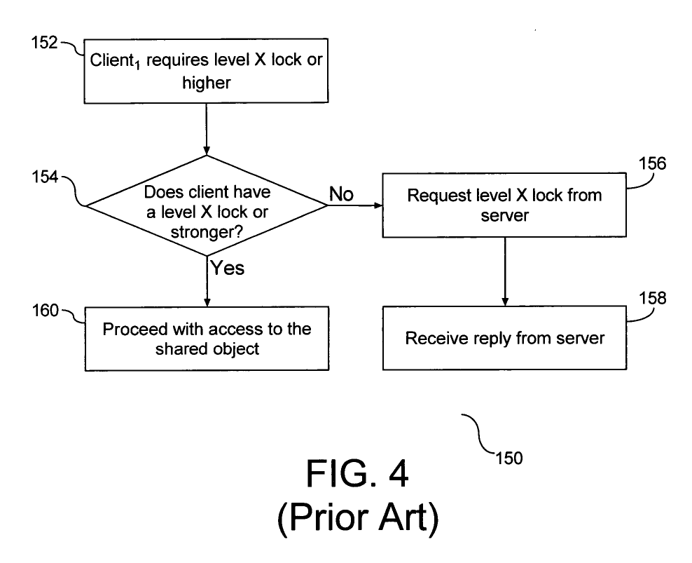

### DESCRIPTION OF THE PREFERRED EMBODIMENT

### Overview

A lock is provided to support concurrent grant of access to read all or a portion of a shared object, while also supporting a grant to write to a portion of the shared object. The lock generalizes a reader-writer lock by providing two additional locking modes in the form of an append mode and a prefix mode. The append mode is a form of a writer mode that enables a client to write data to a shared resource after a marker, and the prefix mode is a form of a reader lock that enables a client to read a shared resource up to a cached marker. With the prefix and append modes, the lock supports additional concurrency when compared to a conventional reader-writer lock for a shared resource in a distributed file system.

### Technical Details

A conventional reader-writer lock is provided with extensions to support enhanced concurrency of read and write applications. One extension is a prefix mode that enables non-exclusive access to a shared object prior to an address value, hereinafter referred to as a marker. When a prefix mode is granted to a client, the client caches the value of an associated marker and the data of the shared object before the marker. Another extension mode is an append mode that enables non-exclusive access to a portion of a shared object after a marker. When an append mode is granted to a client, the client is provided data pertaining to the marker and is only permitted to add data to the object subsequent to this marker. In one embodiment, the marker is an end of file marker.

FIG. 5 is a matrix (250) demonstrating compatibility of reader, writer, append, and prefix modes of a lock. The horizontal projection indicates the granted lock mode (252), and the vertical projection indicates the requested lock mode (254). The +'s indicate that the request lock can be granted in conjunction with the currently held lock, and the −'s indicate that the request is in conflict with the current lock state. As shown, multiple reader lock modes may concurrently be granted for a shared object. Similarly, prefix lock modes and append lock modes may be concurrently granted for a shared object. However, reader and writer lock modes may not be concurrently granted, and multiple writer lock modes may not be concurrently granted.

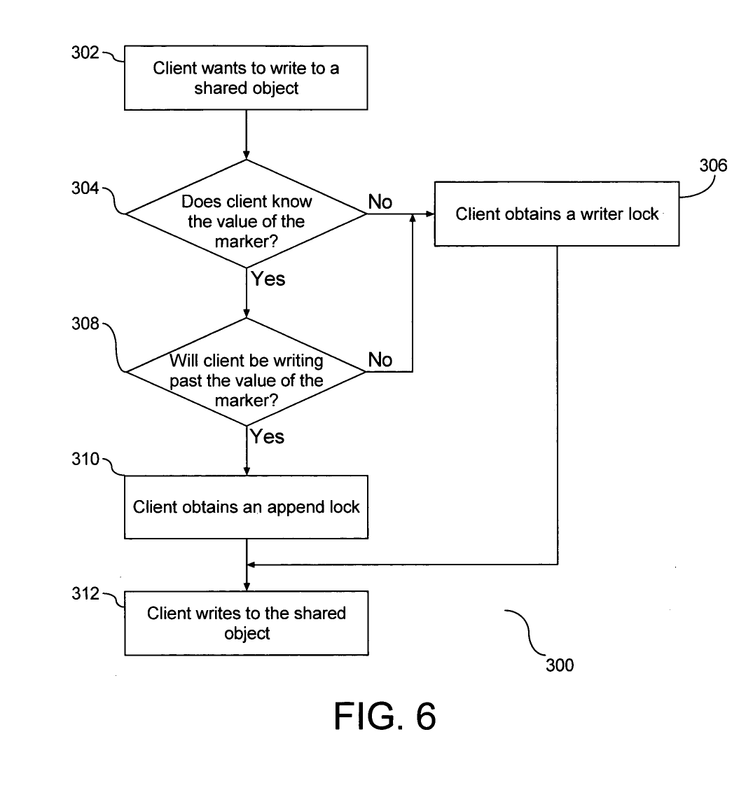

FIG. 6 is a flow chart (300) illustrating the client requesting a form of a writer lock for a shared object from a client perspective. After the client determines it wants to write to a shared object (302), the client conducts a test to determine if it knows the value of the marker (304) as it dictates whether this client's writing will interfere with any potential prefix addresses. If the response to the test at step (304) is negative, the client obtains a writer lock (306). However, if the response to the test at step (304) is positive, a subsequent test is conducted to determine if the client will be writing completely past the value of the marker (308). A negative response to the test at step (308) will result in the client obtaining a writer lock (306). However, a positive response to the test at step (308) will result in the client obtaining an append lock (310). Following the lock acquisition at either step (306) or (310), the client writes to the shared object (312). Accordingly, the client's write process supports determining if the client is appending to the object to permit concurrency with any clients reading before the marker.

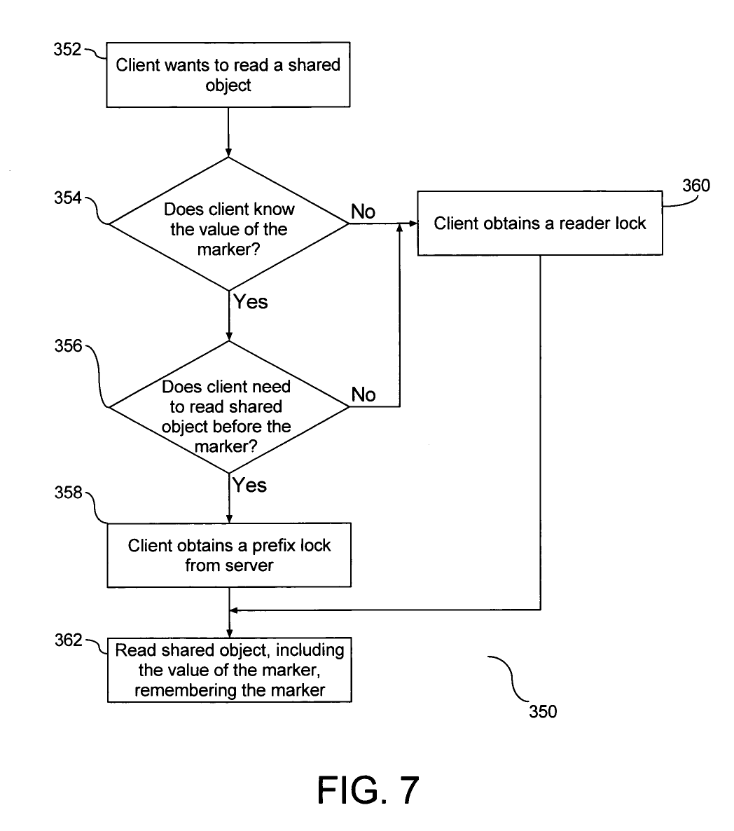

FIG. 7 is a flow chart (350) illustrating a client requesting a reader lock from a server. After the client has determined it wants to read a shared object (352), a test is conducted to determine if the client knows the marker (354). A positive response to the test at step (354) is followed by another test to determine if the client needs to read the shared object before the marker (356). If the response to the test at step (356) is positive, the client requests a prefix lock from the server with the marker value (358) and reads the shared object, including the value of the marker, remembering the marker (362). However, if the response to the test at step (354) is negative, the client obtains a reader lock (360) and reads the shared object remembering the marker (362). Similarly, if the response to the test at step (356) is negative, the client obtains a reader lock (360) and reads the shared object remembering the marker (362). Accordingly, the modified reading process supports retaining knowledge of the marker either before reading the file or after reading the file, thus permitting concurrency of the read operation with the append operation.

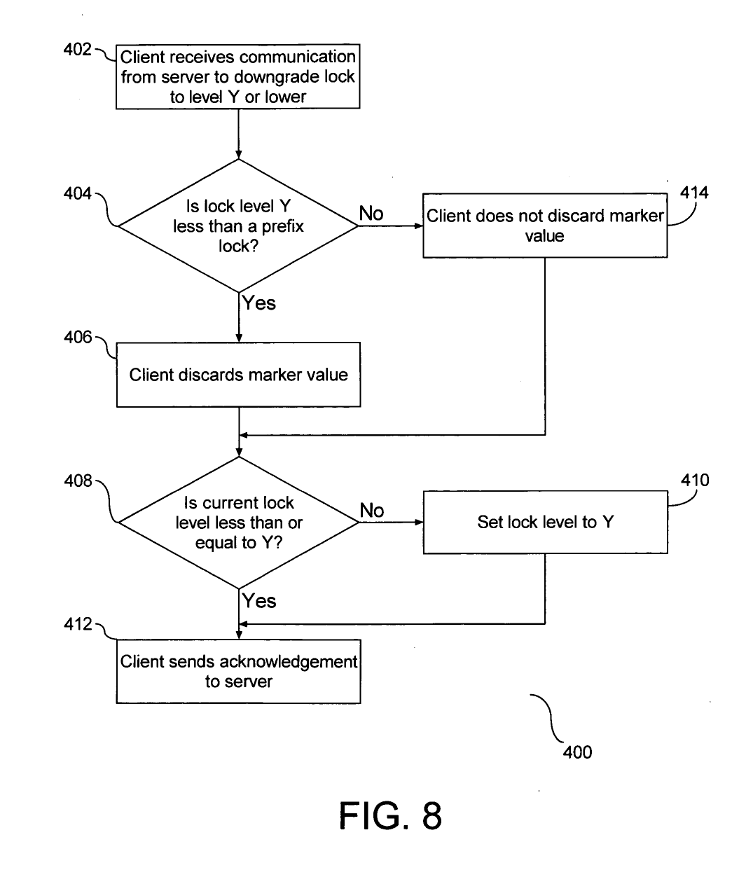

FIG. 8 is a flow chart (400) illustrating a method for a client to manage a lock downgrade request received from a server. The client receives a communication from the server to downgrade the lock to a level y or lower (402), wherein y pertains to a lock level value. The client conducts a test to determine if the lock level request is less than that of a prefix lock (404) in order to determine if the client must discard its memory of the value of the marker. The client must discard the value if other clients with access to the shared object might be writing before the marker. If the response to the test at step (404) is positive, the client must discard the value of the marker (406) because some other client may be changing the value of the marker or may be changing the object's data before the value of the marker. Thereafter, the client conducts a further test to determine if the current lock level is less than or equal to y (408). A positive response to the test at step (408) will result in the client sending an acknowledgement communication that lock level is y or lower to the server (412), whereas a negative response to the test at step (408) will result in the client setting the lock level to y (410) followed by the client sending an acknowledgement communication to the server of the set lock level (312). Similarly, if the response to the test at step (404) is negative, the client does not discard the value of the marker (414) before proceeding to step (408), because the marker dictates the limit of what the prefix lock synchronizes, as described in detail in the above paragraph and shown in FIG. 7. Accordingly, as shown herein the manner in which the client handles a lock downgrade request has been modified to include the marker in limited situations.

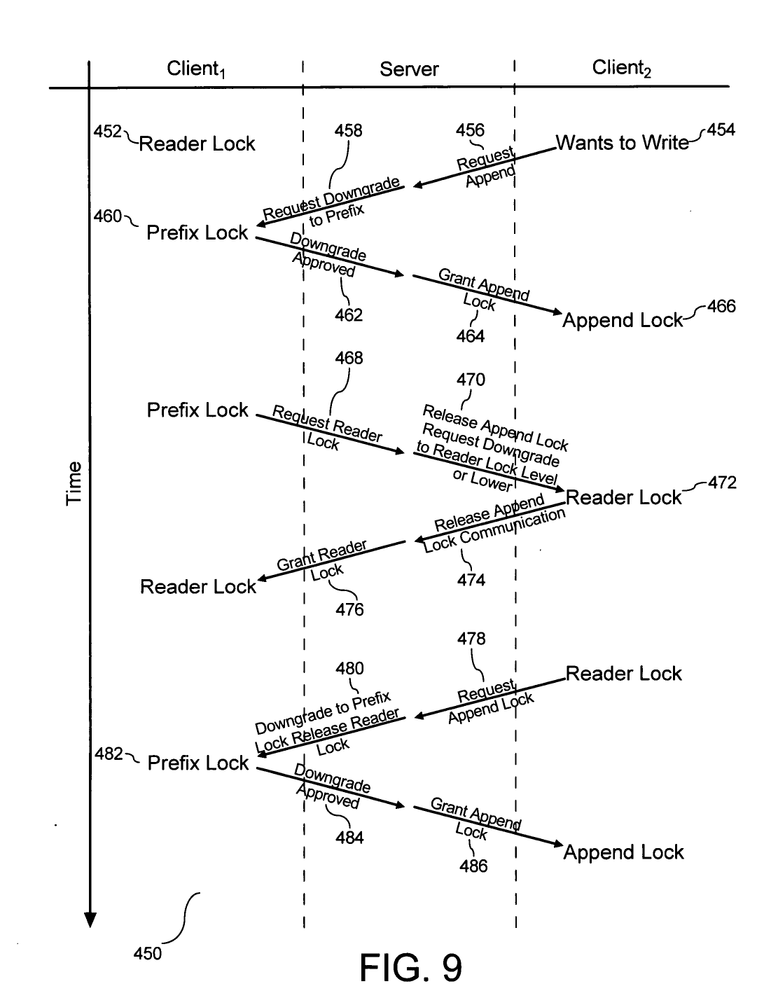

FIGS. 6 and 7 are flow charts illustrating specific instances of the functionality of the lock from the perspective of the clients writing reading of the shared object, respectively. FIG. 9 is a block diagram (450) of a time line showing the communication between two client machines, client₁ and client₂, sharing access to a resource through a server. At the initial step of the time line, client₁ is in possession of a reader lock (452), and client₂ want a writer lock to write past a marker (454). Client₂ sends a request for an append lock to the server (456). In response to the append lock request, the server sends a downgrade request to client₁ in possession of the reader lock to downgrade to a prefix lock (458). If client₁ approves of the downgrade to the prefix lock, the client sets the lock to a prefix lock (460) and sends a downgrade approval communication to the server (462). The server then responds to client₂ with a grant of an append lock (464) after which client₂ uses the append lock to write data to the shared object past the marker (466). Client₂ in possession of the append lock is able to write past the marker concurrent with client₁ in possession of the prefix lock reading data of the shared object up to the marker. While client₁ is in possession of the prefix lock (460) it sends a request to the server for a reader lock to enable it to read past the saved marker (468). In response to the received request, the server sends a communication requesting client₂ to release the append lock, downgrading to a reader lock level or lower (470). As shown, upon receiving the communication at step (470), client₂ changes its lock level to a reader lock (472) followed by an append lock release communication to the server (474). The server sends a communication to client, granting it a reader lock (476). In the illustration, client₂ is downgraded from an append lock to a reader lock upon grant of the reader lock to client₁. Following the concurrent grant of reader locks to both clients, client₂ sends a communication to the server requesting an append lock (478). The server responds to the client₂ communication by requesting client, to downgrade from a reader lock to a prefix lock (480). As shown, client₁ approves the downgrade to the prefix lock (482) and sends a downgrade approval communication to the server (484) indicating the approval and associated downgrade. The server responds to the communication by granting an append lock to client₂ (486). Accordingly, the modified reader-writer lock supports enhanced concurrency of read and write operations to a shared object through the use of the prefix and append modes.

When a client obtains a prefix lock mode, it reads the object and obtains the marker value from the server, as shown at steps 358 and 362 in FIG. 7. This enables the client to read data for the object before the marker while another client may be writing data to the object past the marker. In order for the client to refresh the object to include a new value for the marker after another client has appended data to the object, the client must upgrade the prefix lock mode to a reader lock mode and during this process revoke any append lock modes held by other clients. Similarly, a client in possession of an append lock mode may add new data to the object but may not affect data before the marker. As the client in possession of the append lock mode updates the marker with the server, the server may likewise communicate that update to any prefix lock mode holders. In one embodiment, the communication of the new marker from an append lock mode to a prefix lock mode may be in the form of a near-instantaneous update of file attributes. The lock modes preferably include a manager to mediate lock mode requests responsive to the properties of the reader, writer, append, and prefix modes. In one embodiment, the manager may be embedded in a computer-readable medium in the form of code or associated instructions. Similarly, each of the lock modes may be in the form of instructions in a computer-readable medium that support the defined lock modes.

### Advantages Over The Prior Art

The lock modes support enhanced concurrency of both read and write operations of a shared object compared to a conventional reader-writer lock. The prefix mode of the extensions enables a client to cache data from the shared object up to a marker, and to read the associated data. While one or more clients may be granted a prefix lock mode, a second client may be granted an append lock mode to the same resource. The append lock mode supports the second client writing data to the same object after the marker.

### ALTERNATIVE EMBODIMENTS

It will be appreciated that, although specific embodiments of the invention have been described herein for purposes of illustration, various modifications may be made without departing from the spirit and scope of the invention. In particular, the reader-writer lock modes may be applied to any computer system that supports shared resources and access to such resources by more than a single point of entry. Also, as noted each lock holder or requesting lock holder is sent a communication regarding the requesting lock mode. The communication may be in the form of a remote procedure call, a message, or another form of communication between lock holders and lock requesters. Accordingly, the scope of protection of this invention is limited only by the following claims and their equivalents.

We claim:

1. A lock for a shared object comprising:
a reader mode adapted to support non-exclusive access to read a shared object;
a writer mode adapted to support exclusive access to modify said object;
an append mode adapted to support non-exclusive access to said object and to support a modification to said object after a marker; and
a prefix mode adapted to support non-exclusive access to read said object earlier than said marker; and
a manager adapted to mediate a lock request responsive to said modes.

2. The lock of claim 1, further comprising a notification of a lock request adapted to be communicated to said manager and a response adapted to be communicated from said manager to a holder of a non-compatible lock mode said response being a downgrade of said non-compatible mode to a compatible mode to support grant of said lock request

3. The lock of claim 1, further comprising a lock coexistence protocol adapted to support concurrent grant of a first prefix mode with a second prefix mode, concurrent grant of a reader mode with a prefix mode, concurrent grant of a first reader mode with a second reader mode, and concurrent grant of an append mode with a prefix mode.

4. The lock of claim 1, further comprising a communication adapted to be sent from a request of an append mode to an active reader mode to request a mode change of said reader mode to a prefix mode.

5. The lock of claim 1, further comprising a writer mode request adapted to communicate a mode change request to a holder of a lock to a lock mode selected from a group consisting of: prefix, append, writer, and reader.

6. The lock of claim 1, further comprising a near-instantaneous update of file attributes adapted to be communicated from said manager to a prefix mode holder

7. The lock of claim 1, further comprising an upgrade of said prefix mode to a reader mode and revocation of any held append modes in response to a refresh of said end of file marker.

8. A method for managing a shared object in a computer system comprising:
providing a lock including:
a reader mode supporting non-exclusive access to read a shared object;
a writer mode supporting exclusive access to modify said object;
an append mode supporting non-exclusive access to modify said object after an end of file marker; and
a prefix mode supporting non-exclusive access to read said object earlier than an end of file marker; and
mediating mode requests within said lock in response to said modes.

9. The method of claim 8, further comprising communicating a lock request to a mediator and communicating a response from said mediator to a holder of a non-compatible lock mode, wherein said response is a downgrade of said non-compatible mode to a compatible mode to support grant of said lock request.

10. The method of claim 8, further comprising supporting coexisting of a first prefix mode with a second prefix mode, a reader mode with a prefix mode, concurrent grant of a first reader mode with a second reader mode, and an append mode with a prefix mode.

11. The method of claim 8, further comprising sending a communication from an append mode request to an active reader mode, wherein said request includes instructing said active reader mode to change said mode to a prefix mode.

12. The method of claim 8, further comprising sending a communication from a writer mode request to an active mode selected from a group consisting of: prefix, append, writer, and reader, wherein said request include instructing said client to downgrade said mode.

13. The method of claim 8, further comprising communicating a near-instantaneous update of file attributes to an active prefix mode from a mediator.

14. The method of claim 8, further comprising upgrading said prefix mode to a read mode, including revoking any held append modes, in response to a refresh of said end of file marker.

15. An article comprising:
a computer-readable signal bearing medium;
means in the medium for supporting management of a shared object, wherein said means includes instructions to support lock modes comprising:
a reader mode for supporting non-exclusive access to read a shared object;
a writer mode for supporting exclusive access to modify said object;
an append mode for supporting non-exclusive access to said object and supporting a modification to said object after a marker; and
a prefix mode for supporting non-exclusive access to read said object earlier than said marker; and
means in the medium for mediating a lock request responsive to said modes.

16. The article of claim 15, wherein said means for mediating a lock request responsive to said modes includes communicating a downgrade of said non-compatible mode to a compatible mode to a holder of a non-compatible lock mode to support grant of said lock request.

17. The article of claim 15, wherein said means for supporting management of a shared object include supporting coexisting of a first prefix mode with a second prefix mode, a reader mode with a prefix mode, a first reader mode with a second reader mode, and an append mode with a prefix mode.

18. The article of claim 15, wherein said means for mediating a lock request responsive to said modes includes sending a communication from an append mode holder to a reader mode, wherein said communication includes instructing said reader mode to change said mode to a prefix mode.

19. The article of claim 15, further comprising means for communicating a near-instantaneous update of file attributes to a prefix mode from a mediator responsive to a communication from an append mode holder.

20. The article of claim 15, further comprising means for upgrading said prefix mode to a reader mode, including revoking any held append modes, in response to a refresh of said marker.
